(19) United States
(12) Patent Application Publication
(10) Pub. No.: US 2022/0188741 A1
(43) Pub. Date: Jun. 16, 2022

(54) ELECTRONIC APPARATUS AND INFORMATION PROVIDING METHOD THEREOF

(71) Applicant: Coupang Corp., Seoul (KR)

(72) Inventors: Young Shin KANG, Seoul (KR); Hye Joon CHA, Seoul (KR); Seung Hoon PARK, Seoul (KR); Hong Gyem KIM, Seoul (KR)

(21) Appl. No.: 17/153,269

(22) Filed: Jan. 20, 2021

(30) Foreign Application Priority Data
Dec. 11, 2020 (KR) 10-2020-0173259

(51) Int. Cl. G06Q 10/08

(52) U.S. Cl. CPC G06Q 10/083

(57) ABSTRACT

An information providing method of an electronic apparatus is disclosed. The information providing method may include acquiring order information for at least one sub-center, the order information including ordered item information and item quantity information on an ordered item, checking information on a number of vehicles for each of a plurality of vehicle types required for delivery to the at least one sub-center based on the order information, and providing the checked information on the number of vehicles for each of the vehicle types.

### BACKGROUND

### Technical Field

The present disclosure relates to an electronic apparatus for providing information on a number of vehicles for each of a plurality of vehicle types according to order information, and an information providing method thereof.

### Description of the Related Art

Hundreds of thousands of items are being delivered on average per day. For item delivery services, it is becoming more competitive to quickly deliver the ordered items to customers. Accordingly, many distribution centers are being installed to quickly deliver items to customers, and such a distribution center may be divided into a main center and a sub-center. Items can be delivered from the main center to the sub-center, and items that customers order may be delivered from the sub-center to the customers. For the delivery of the items from the main center to the sub-center, there is a need for a technology that enables information on the number of vehicles to be provided for each of the vehicle types.

### SUMMARY

### Technical Goals

Example embodiments disclosed herein are directed to providing an electronic apparatus and an information providing method thereof. The technical goals to be achieved by the example embodiments of the present disclosure are not limited to the technical goals described above, and other technical goals may be inferred from the following example embodiments.

### Technical Solutions

According to a first example embodiment, there is provided an information providing method of an electronic apparatus, the information providing method comprising acquiring order information for at least one sub-center, the order information including ordered item information and item quantity information on an ordered item, checking information on a number of vehicles for each of a plurality of vehicle types required for delivery to the at least one sub-center based on the order information, and providing the checked information on the number of vehicles for each of the vehicle types.

The information providing method may further include providing first item quantity information on an item quantity for which a vehicle is allocated and second item quantity information on an item quantity for which a vehicle is not allocated, among a quantity of items ordered for the at least one sub-center based on the item quantity information and the information on the number of vehicles for each of the vehicle types.

The checking of the information on the number of vehicles for each of the vehicle types may include checking first information corresponding to a quantity of ordered items included in a specific category based on item category information corresponding to the ordered item information, checking second information corresponding to a size of an ordered item included in the specific category, and checking information on a number of vehicles for each of the vehicle types corresponding to the specific category based on the first information and the second information.

The information on the number of vehicles for each of the vehicle types may be determined based on a comparison between the first information and the second information and a preset capacity out of a loading capacity of vehicles.

The order information may be determined based on stock information of the sub-center and stock information of a main center.

The order information may be determined based on history information of delivery to a purchaser for a preset period in the sub-center.

The order information may be updated every order date, and a correspondence relationship between the sub-center and the main center may be updated every order date.

The sub-center may correspond to a center delivering an item ordered by a purchaser in a corresponding coverage range, and the main center may correspond to a center delivering an item to the at least one sub-center.

According to a second example embodiment, there is also provided an electronic apparatus including a communication device, a display, and a controller configured to acquire order information for at least one sub-center, the order information including ordered item information and item quantity information on an ordered item, check information on a number of vehicles for each of the vehicle types required for delivery to the at least one sub-center based on the order information, and provide the checked information on the number of vehicles for each of the vehicle types.

According to a third example embodiment, there is also provided a computer-readable recording medium including a non-transitory recording medium on which a program allowing a computer to execute the above-described method is recorded.

Detailed content of other embodiments is described in a detailed description and illustrated in the accompanying drawings.

### Effects

According to the present disclosure, an electronic apparatus may check and provide the information on the number of vehicles for each of the vehicle types required for delivery to the sub-center based on the order information including the information on the ordered items and the information on the quantity of the items. When items correspond to a specific category, the information on the number of vehicles for each of the vehicle types corresponding to the specific category may be provided. In this case, the number of vehicles may be determined based on the size and quantity of items, and the type of vehicles may be determined based on the category of the items. For this reason, it is possible to quickly and accurately deliver the items according to order information from the main center to the sub-center.

Effects of the present disclosure are not limited to the above-described effects, and other effects that are not described will be clearly understood by those skilled in the art from the description of the claims.

### BRIEF DESCRIPTION OF THE DRAWINGS

FIG. 1 illustrates a system according to an example embodiment.

FIG. 2 illustrates an electronic apparatus that provides information on the number of vehicles for each of the vehicle types for delivering items between a main center and a sub-center according to an example embodiment.

FIG. 3 illustrates an information providing method of an electronic apparatus according to an example embodiment.

FIG. 4 illustrates order information related to a plurality of sub-centers according to an example embodiment.

FIG. 5 is a block diagram of an electronic apparatus according to an example embodiment.

### DETAILED DESCRIPTION

General terms that are currently widely used are selected as terms used in example embodiments in consideration of functions in the present disclosure but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise specified, “including” any component means that other components may be further included rather than excluding other components. In addition, the terms “unit,” “module,” and the like, described in the specification refer to a processing unit of at least one function or operation and may be implemented by hardware or software or a combination of hardware and software.

The expression “at least one of a, b, and c” described throughout the specification may include “a alone,” “b alone,” “c alone,” “a and b,” “a and c,” “b and c,” or “all of a, b, and c.”

A “terminal” described below may be implemented as a computer or a portable terminal that may access a server or other terminals through a network. Here, computers may include, for example, a notebook, a desktop, a laptop, and the like, which are equipped with a web browser, and portable terminals are wireless communication devices that ensure portability and mobility, and may include, for example, communication-based terminals using International Mobile Telecommunication (IMT), code division multiple access (CDMA), W-code division multiple access (W-CDMA), or Long Term Evolution (LTE), and all kinds of handheld-based wireless communication devices such as a smartphone and a tablet PC.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described in detail with reference to the drawings.

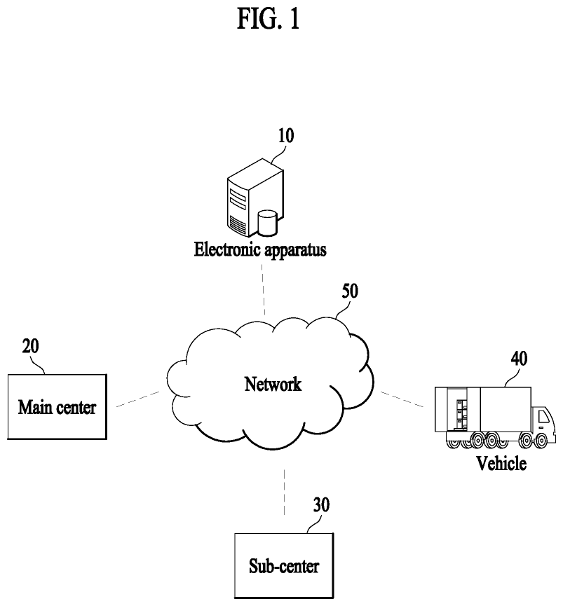

FIG. 1 illustrates a system according to an example embodiment.

Referring to FIG. 1, the system may include an electronic apparatus 10, a main center 20, a sub-center 30, a vehicle 40, and a network 50. In the system illustrated in FIG. 1, only components related to the present example embodiment are illustrated. Accordingly, it can be understood by those of ordinary skill in the art related to the present example embodiment that other general-purpose components may be further included in addition to the components illustrated in FIG. 1.

The electronic apparatus 10, the main center 20, the sub-center 30, and the vehicle 40 may communicate with each other through the network 50. The network 50 may include a local area network (LAN), a wide area network (WAN), a value-added network (VAN), a mobile radio communication network, a satellite communication network, or a combination thereof, may be a data communication network in a comprehensive meaning that enables configuration subjects of each network illustrated in FIG. 1 to smoothly communicate with each other, and may include wired Internet, wireless Internet, or a mobile wireless communication network. The wireless communication may include, for example, wireless LAN (Wi-Fi), Bluetooth, Bluetooth low energy, ZigBee, Wi-Fi direct (WFD), ultra wideband (UWB), Infrared Data Association (IrDA), near field communication (NFC), or the like but is not limited thereto.

The electronic apparatus 10 may provide all information related to delivery and may be included in a server providing information related to the delivery. Specifically, the electronic apparatus 10 may provide related information when delivering items from the main center 20 to the sub-center 30, the electronic apparatus 10 may provide information related to the vehicle 40 used when delivering items from the main center 20 to the sub-center 30, or the electronic apparatus 10 may provide related information when delivering items from the sub-center 30 to a purchaser. The number of main centers 20, sub-centers 30, and vehicles 40 illustrated in FIG. 1 is exemplary and is not limited thereto.

Here, the sub-center 30 may be a center that delivers items ordered by a purchaser in a corresponding coverage range. For example, sub-center 1 may be a center that delivers items ordered by a purchaser in area 1 corresponding to coverage range 1, sub-center 2 may be a center that delivers items ordered by a purchaser in area 2 corresponding to coverage range 2, and sub-center 3 may be a center that delivers items ordered by a purchaser in area 3 corresponding to coverage range 3. The electronic apparatus 10 may analyze order information in the corresponding areas of each sub-center to manage the sub-centers to hold items in stock so that the corresponding items may be ordered in each sub-center. For example, the electronic apparatus may analyze order information for each period in area 1 to manage sub-center 1 to hold stock of items predicted to be ordered, or may analyze order information for each period in area 2 to manage sub-center 2 to hold stock of items predicted to be ordered.

In addition, the main center 20 may be a center that delivers items to at least one sub-center 30. For example, main center 1 may be a center that delivers items to sub-center 1 and sub-center 2, and main center 2 may be a center that delivers items to sub-center 3 to sub-center 5. In this case, the correspondence relationship between the main center and the sub-center may be different every order date on which order information is updated. For example, on Dec. 1, 2020, main center 1 may deliver items to sub-center 1 and sub-center 2, but on Dec. 3, 2020, main center 1 may deliver items to sub-center 2 to sub-center 4.

The vehicle 40 may be used when delivering items from the main center 20 to the sub-center 30, and the electronic apparatus 10 may check the number of vehicles for each of a plurality of vehicle types based on the order information. For example, the electronic apparatus 10 may determine that three freezer vehicles, ten refrigerator vehicles, and twenty general vehicles are required to deliver items from main center 1 to sub-center 2 based on the order information on Dec. 1, 2020. In addition, the electronic apparatus 10 may determine that one freezer vehicle, fifteen refrigerator vehicles, and seven general vehicles are required to deliver items from main center 1 to sub-center 3 based on the order information on Dec. 3, 2020.

In this case, the electronic apparatus 10 may determine the number of vehicles for each of the vehicle types based on information related to the items delivered from the main center 20 to the sub-center 30 and the information related to the vehicle 40 delivering the items. Items may be delivered from the main center 20 to the sub-center 30 based on the number of vehicles determined by the electronic apparatus 10 for each of the vehicle types.

Hereinafter, specific processes performed in the electronic apparatus 10, the main center 20, the sub-center 30, and the vehicle 40 in connection with providing information will be described.

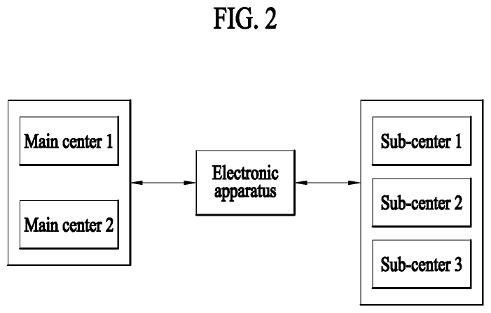

FIG. 2 illustrates an electronic apparatus that provides information on the number of vehicles for each of the vehicle types for delivering items between a main center and a sub center according to an example embodiment. Main center 1, main center 2, and sub-center 1 to sub-center 3 illustrated in FIG. 2 are only exemplary and are not limited thereto.

Referring to FIG. 2, the electronic apparatus may acquire order information for the sub-center.

According to the example embodiment, the sub-center may monitor stock information, and when it is determined that the stock information is insufficient to approve a purchaser's order for a certain period, the sub-center may request the electronic apparatus to deliver items. For example, when it is determined that stocks of item A and item B in sub-center 1 are insufficient to approve the purchaser's order for the next week, sub-center 1 may request the electronic apparatus to deliver item A and item B. In this case, the electronic apparatus may generate order information in response to the request from the sub-center and transmit the generated order information to the main center. The order information may be determined in consideration of the stock information of the sub-center and the stock information of the main center. For example, the electronic apparatus may monitor the stock information of the plurality of main centers, and the electronic apparatus may check that main center 1 and main center 2 can deliver item A in response to the request from sub-center 1. In this case, the electronic apparatus may transmit order information to main center 1 located closer to sub-center 1 out of main center 1 and main center 2 that are capable of delivering item A, and main center 1 may deliver item A to sub-center 1 based on the order information. In addition, when it is determined that the stock of item B in main center 1 is insufficient to deliver item B from main center 1 to sub-center 1, the electronic apparatus may check stock information of other main centers 3 and 4 that can deliver item B to sub-center 1. In this case, when item C is scheduled to be delivered from main center 3 to sub-center 2 close to sub-center 1, the order information may be transmitted to main center 3 so that item B may be delivered to sub-center 1 while item C is transmitted from main center 3 to sub-center 2.

According to the example embodiment, the electronic apparatus may monitor stock information of the sub-center, and when it is determined that the stock information of the sub-center is insufficient to approve a purchaser's order for a certain period, the electronic apparatus may instruct the main center to deliver items to the sub-center. For example, the electronic apparatus may monitor the stock information of the sub-center, and when it is determined that the stock information of the sub-center is insufficient to approve a purchaser's order for the next period, the electronic device may instruct main center 1, located at a shorter distance among the plurality of main centers capable of delivering items to sub-center 1, to deliver the items to sub-center 1. The electronic apparatus may generate order information when the stock of the sub-center is predicted to be insufficient and transmit the generated order information to the main center. The order information may be determined in consideration of the stock information of the sub-center and the stock information of the main center. For example, the electronic apparatus may monitor the stock information of main center 1 and main center 2, and when it is predicted that the stocks of item A and item B in sub-center 1 are insufficient for the next week, the electronic apparatus may check whether main center 1 and main center 2 can deliver item A. In this case, the electronic apparatus may transmit order information to main center 1 located closer to sub-center 1 out of main center 1 and main center 2 that are capable of delivering item A, and main center 1 may deliver item A to sub-center 1 based on the order information. In addition, when it is determined that the stock of item B in main center 1 is insufficient to deliver item B from main center 1 to sub-center 1, the electronic apparatus may check stock information of other main centers 3 and 4 that can deliver item B to sub-center 1. In this case, when item C is scheduled to be delivered from main center 3 to sub-center 2 that is close to sub-center 1, the order information may be transmitted to main center 3 so that item B may be delivered to sub-center 1 while item C is transmitted from main center 3 to sub-center 2.

The electronic apparatus may determine order information based on history information delivered to a purchaser for a preset period in the sub-center and transmit the determined order information to the main center. Specifically, the electronic apparatus may determine order information on items required for the sub-center based on the history information on the items delivered to the purchaser for the preset period in the sub-center. For example, based on the history information on item A delivered to the purchaser for one week in the sub-center, the electronic apparatus may determine the order information by predicting that the purchaser places an order for item A for the next one week. Alternatively, based on the history information on item B delivered to the purchaser for a specific period including events such as past Christmas in the sub-center, the electronic apparatus may determine the order information by predicting that the purchaser places an order for item B for a specific period including next Christmas. In this case, item B is an item whose order quantity increases more rapidly only for a specific period including an event such as Christmas as compared to other periods, and the electronic apparatus may determine the order information on item B based on the history information for the past Christmas period.

The order information may be updated every order date. The electronic apparatus may generate and update the order information for the sub-center every order date. In this case, the correspondence relationship between the sub-center and the main center may be variably updated every order date. For example, the order information may be generated so that items are delivered from main center 1 to sub-center 1 and sub-center 2 and items are delivered from main center 2 to sub-center 3 on Dec. 3, 2020. Alternatively, the order information may be generated so that items are delivered from main center 1 to sub-center 1 and items are delivered from main center 2 to sub-center 3 on Dec. 4, 2020. That is, the correspondence relationship between the sub-center and the main center is not fixed and may vary based on the order information. The electronic apparatus may monitor the stock information of the main center and may instruct to replenish the items of the main center when the stock of the main center is predicted to be insufficient. In this case, the electronic apparatus may manage the delivery status from the main center to the sub-center and instruct a major main center to replenish items in the order of priority. Here, the major main center may be determined based on the number of times the order information is received from the electronic apparatus.

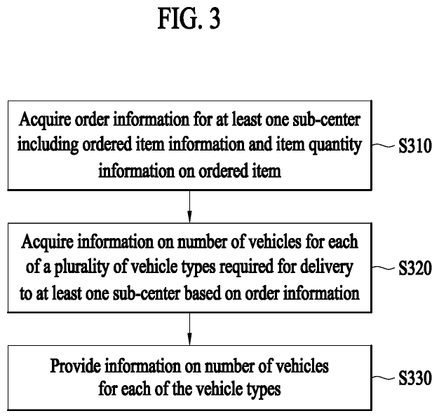

FIG. 3 illustrates an example of an information providing method of an electronic apparatus.

Referring to FIG. 3, in operation S310, the electronic apparatus may acquire order information for at least one sub-center including ordered item information and item quantity information of an ordered item.

Here, the order information may be determined in consideration of the stock information of the sub-center and the stock information of the main center. Specifically, when the sub-center requests an order to the electronic apparatus, the electronic apparatus may transmit the order information to the main center holding stock capable of delivering item X to the sub-center requesting an order, among the plurality of main centers. In this case, the electronic apparatus may check the stock information on item X of the sub-center and check the main center that holds the item quantity information of item X required for the sub-center based on the stock information of the main center. The electronic apparatus may transmit the order information to the main center close to the sub-center among the plurality of main centers that hold the item quantity information of item X in the order of priority. Alternatively, the electronic apparatus may monitor the stock information of the sub-center, and as a result of the monitoring, it may be predicted that an order for item X is required for a certain period (for example, next week). The electronic apparatus may check the main center that holds the item quantity information of item X and may transmit the order information to the corresponding main center.

In addition, the order information is determined based on the history information delivered to the purchaser for the preset period in the sub-center. The electronic apparatus may analyze the order information within the coverage range that the sub-center is in charge of, and analyze the list of items and the quantity of items that are mainly purchased for a certain period (for example, one week) in the sub-center. Alternatively, the electronic apparatus may analyze the order information within the coverage range that the sub-center is in charge of for an event period (for example, one week including Halloween) and analyze the list of items and the quantity of items that are purchased for the event period in the corresponding sub-center. The electronic apparatus may analyze past order information to check the history information delivered to the purchaser and thus determine the order information on items predicted to be required in the sub-center in consideration of the stock information of the sub-center. Alternatively, the electronic apparatus may analyze features (for example, age, sex, occupation, and the like) of a purchaser and an order inclination within the coverage range covered by the sub-center and analyze the items that the corresponding sub-center needs to hold, thereby determining the order information based on the analysis.

In operation S320, the electronic apparatus may check information on a number of vehicles for each of the vehicle types required for delivery to at least one sub-center based on the order information. In addition, in operation S330, the electronic apparatus may provide the checked information on the number of vehicles for each of the vehicle types.

The electronic apparatus may transmit the order information to the main center, and the main center may deliver items according to the order information to the sub-center using a vehicle. In this case, the electronic apparatus may check the number of vehicles for each of the vehicle types required for delivery.

Specifically, the electronic apparatus may check first information corresponding to a quantity of the ordered items included in a specific category based on item category information corresponding to the information on the ordered item. Items can be classified into frozen items, refrigerated items, and room temperature items by category, and the electronic apparatus may check the first information corresponding to the quantity of items included in the specific category. For example, the electronic apparatus may check 100 frozen items A, 50 refrigerated items B, and 200 room temperature items C ordered for delivery to sub-center 1.

In addition, the electronic apparatus may check second information corresponding to a size of an ordered item included in a specific category. For example, the electronic apparatus may check information corresponding to a size of frozen item A, a size of refrigerated item B, and a size of room temperature item C.

The electronic apparatus may check a capacity required to deliver the item corresponding to the specific category based on the first information and the second information. For example, capacity 1 required to deliver frozen item A may be checked using the size of frozen item A and 100 frozen items A. In addition, capacity 2 required to deliver refrigerated item B may be checked using the size of refrigerated item B and 50 refrigerated items B. In addition, capacity 3 required to deliver room temperature item C may be checked using the size of room temperature item C and 200 room temperature items C.

The electronic apparatus may check the information on the number of vehicles for each of the vehicle types to deliver items corresponding to a specific category. In this case, each vehicle has a determined loading capacity, and the electronic apparatus may check the information on the number of vehicles for each of the vehicle types in consideration of a preset capacity among the loading capacities in consideration of safety. Here, the preset capacity may be different for each of the vehicle types, and the electronic apparatus may check the information on the number of vehicles for each of the vehicle types so that only an amount of items corresponding to the preset capacity within the loading capacity may be loaded. Specifically, considering capacity 1 and 70% loading capacity of the refrigerator vehicle, the electronic apparatus may check the information on the number of refrigerator vehicles required for delivery. In addition, considering capacity 2 and 60% loading capacity of the refrigerator vehicle, the electronic apparatus may check the information on the number of refrigerator vehicles required for delivery. In addition, considering capacity 3 and 80% loading capacity of the general vehicle, the electronic apparatus may check the information on the number of general vehicles required for delivery. Therefore, the electronic apparatus may check and provide the information on the number of vehicles for each of the vehicle types required for the delivery of items ordered from the main center to the sub-center. The electronic apparatus may update the stock information of the main center when the item is delivered from the main center to the sub-center based on the order information.

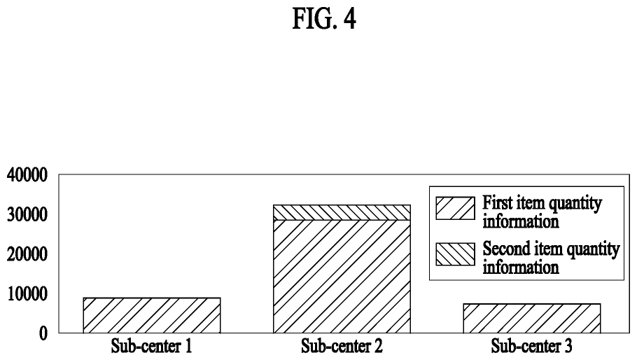

FIG. 4 illustrates order information related to a plurality of sub-centers according to an example embodiment.

Referring to FIG. 4, the electronic apparatus may transmit the order information for sub-center 1, sub-center 2, and sub-center 3 to the main center, and the main center may transmit items to sub-center 1, sub-center 2, and sub-center 3 based on the order information.

The order information may include the information on the ordered item and the information on the quantity of the ordered items for the sub-center. For example, the order information may include the list of items and the information on the quantity of each item delivered to sub-center 1, sub-center 2, and sub-center 3. Here, the list of items and the information on the quantity of each item delivered to each sub-center may be different.

The electronic apparatus may inquire about vehicles available in the main center and may check the information on the number of vehicles for each of the vehicle types required for the delivery according to the order information from the main center to sub-center 1 based on the order information for sub-center 1. For example, the electronic apparatus may inquire about vehicles available in the main center and may check 10 freezer vehicles and 15 refrigerator vehicles required for delivery of frozen items and refrigerated items to sub-center 1 according to the order information.

In this case, the electronic apparatus may provide first item quantity information on a quantity of the ordered items of which order has been confirmed and second item quantity information on a quantity of the ordered items of which order has not been confirmed among the quantity of the ordered items for the sub-center based on the item quantity information and the information on the number of vehicle for each of the vehicle types. The first item quantity information on the quantity of items of which order has been confirmed may be the information on the quantity of items to which a vehicle is allocated, and the second item quantity information on the quantity of items of which order has not been confirmed may be the information on the quantity of items to which a vehicle is not allocated.

When the number of vehicles required to deliver items to sub-center 1, sub-center 2, and sub-center 3 among the vehicles available in the main center is insufficient, the vehicles may be allocated to each sub-center based on priority information. For example, among vehicles available in the main center, vehicles may be allocated in the order of sub-center 1, sub-center 3, and sub-center 2. In this case, the priority information may be determined in consideration of the stock information of the sub-center. Specifically, vehicles may first be allocated in the order in which stock of items to be delivered to the sub-center is relatively small For example, based on the stock information of sub-center 1, the number of stocks of items to be delivered may be relatively small in sub-center 1, and based on the stock information of sub-center 2, the number of stocks of items to be delivered may be relatively large in sub-center 2. In this case, the electronic apparatus may allocate vehicles in the order of sub-center 1, sub-center 3, and sub-center 2 among the vehicles available in the main center. As a result, in connection with sub-center 2, the first item quantity information on the quantity of items of which order has been confirmed and the second item quantity information on the quantity of items of which order has not been confirmed may occur. The electronic apparatus may search for a plurality of different main centers that may deliver the second item quantity information to sub-center 2 and may transmit the order information corresponding to the second item quantity information to another main center located close to the sub-center among the plurality of other main centers. Specifically, when the item corresponding to the second item quantity information is a fresh item that needs to be delivered from sub-center 2 to the purchaser on that day, the electronic apparatus may transmit the order information corresponding to the second item quantity information to another main center located close to sub-center 2 among the plurality of other main centers in consideration of the characteristics of the item corresponding to the second item quantity information. In addition, the electronic apparatus may inquire about the vehicles available in other main centers that have received the order information and allocate the vehicles for sub-center 2 in the order of priority. Alternatively, in connection with the second item quantity information on the quantity of items to which the vehicle is not allocated, when the vehicles are predicted to return in consideration of the estimated arrival time of some of the vehicles that deliver items to sub-center 1 to sub-center 3, the electronic apparatus may allocate vehicles in the order of priority by predicting the available vehicles according to the return of the vehicles to deliver the items according to the second item quantity information to sub-center 2. Specifically, when the item corresponding to the second item quantity information is not a fresh item that needs to be delivered from sub-center 2 to the purchaser on that day, the electronic apparatus may allocate the vehicles in the order of priority by predicting the vehicles returning to the main center in consideration of the characteristics of the items and deliver the items according to the second information on the quantity of items to sub-center 2. Alternatively, when the electronic apparatus predicts that the number of vehicles available in main center 1 is insufficient to deliver the items according to the order information, the electronic apparatus may predict the insufficiency and instruct a vehicle related to another main center to move to main center 1. For example, when it is determined that there are insufficient vehicles available to deliver items according to the order information from main center 1 tomorrow, the electronic apparatus may search for idle vehicles at main center 2 located within a short distance and instruct the idle vehicles to move to main center 1.

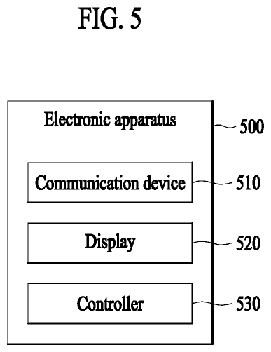

FIG. 5 is a block diagram of an electronic apparatus according to an example embodiment.

An electronic apparatus 500 may include a communication device 510, a display 520, and a controller 530 according to the example embodiment. In the electronic apparatus 500 illustrated in FIG. 5, only components related to the present example embodiment are illustrated. Accordingly, it can be understood by those of ordinary skill in the art related to the present example embodiment that other general-purpose components may be further included in addition to the components illustrated in FIG. 5. The electronic apparatus 500 may include contents related to the above-described electronic apparatus, and therefore, a description of overlapping contents will be omitted.

The communication device 510 is a device for performing wired/wireless communication and may communicate with the main center or the sub-center. In addition, communication technologies used by the communication device 510 may include Global System for Mobile Communication (GSM), code division multi access (CDMA), Long Term Evolution (LTE), 5G, wireless LAN (WLAN), wireless-fidelity (Wi-Fi), Bluetooth™, radio frequency identification (RFID), Infrared Data Association (IrDA), ZigBee, near field communication (NFC), or the like. In an example embodiment, the communication device 510 may be referred to as a transceiver, and the electronic apparatus 500 may exchange information with the center through the transceiver.

The display 520 may display information related to the operation of the electronic apparatus 500.

The controller 530 may control the overall operation of the electronic apparatus 500 and process data and signals. The controller 530 may be configured as at least one hardware unit. Further, the controller 530 may be operated by one or more software modules generated by executing program codes stored in the memory. The controller 530 may include a processor and a memory, and the processor may control the overall operation of the electronic apparatus 500 and process data and signals by executing program codes stored in the memory. Also, in an example embodiment, the controller 530 may include at least one processor.

The controller 530 may acquire the order information, inquire about vehicles available in the main center, check the number of vehicles required for delivery to at least one sub-center based on the order information, and determine the checked information on the number of vehicles for each of the vehicle types. In this case, the controller 530 may check the first information corresponding to the quantity of the ordered items included in the specific category based on the category information on the item, and check the second information corresponding to the size of the ordered item included in the specific category. The controller 530 may check the information on the number of vehicles for each of the vehicle types corresponding to the specific category based on the first information and the second information. In this case, the controller 530 may determine the information on the number of vehicles for each of the vehicle types in consideration of the loading capacity of the vehicle. In addition, the controller 530 may determine the order information based on the history information delivered to the purchaser for the preset period in the sub-center.

The electronic apparatus or terminal according to the above-described example embodiments may include a processor, a memory that stores and executes program data, a permanent storage such as a disk drive, a communication port that communicates with an external device, a touch panel, a key, a user interface device such as a button, and the like. Methods implemented as software modules or algorithms may be stored on a computer-readable recording medium as computer-readable codes or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a CD-ROM or digital versatile disc (DVD)), and the like. The computer-readable recording medium may be distributed in computer systems connected to each other through a network, and as a result, the computer-readable codes may be stored and executed in a distributed scheme. The medium may be readable by a computer, stored in a memory, and executed on a processor.

The present example embodiment may be represented by functional block configurations and various processing operations. These functional blocks may be implemented by various numbers of hardware and/or software components that execute specific functions. For example, the example embodiment may employ integrated circuit configurations, such as memory, processing, logic, and a look-up table, capable of executing various functions by control of one or more microprocessors or other control devices. Similar to executing the components in software programming or software elements, the present example embodiment can be implemented in programming or scripting languages such as C, C++, Java, and assembler, including various algorithms implemented by a combination of data structures, processes, routines or other programming configurations. Functional aspects may be implemented in algorithms executed on one or more processors. In addition, the present example embodiment may employ a conventional technology for electronic environment setting, signal processing, and/or data processing, and the like. Terms such as “mechanism,” “element,” “means,” and “configuration” may be used widely and are not limited to mechanical and physical configurations. The terms may include the meaning of a series of routines of software in connection with a processor or the like.

The above-described example embodiments are merely examples, and other embodiments may be implemented within the scope of the following claims.

1. An information providing method of an electronic apparatus, the electronic apparatus comprising a communication device and a controller, the information providing method comprising:
acquiring order information for at least one sub-center from the at least one sub-center of a first main center via the communication device, the order information comprising ordered item information and item quantity information on an ordered item;
determining, via the controller, a number of vehicles for each of a plurality of vehicle types required for delivery of the ordered item to the at least one sub-center based on the ordered item information and the item quantity information, the plurality of vehicle types including freezer vehicles, refrigerator vehicles, and general vehicles;
providing the determined number of vehicles for each of the vehicle types required for delivery of the ordered item to the first main center via the communication device;
providing first item quantity information on an item quantity for which a vehicle is allocated and second item quantity information on an item quantity for which a vehicle is not allocated, among a quantity of items ordered for the at least one sub-center based on the item quantity information and the information on the number of vehicles for each of the vehicle types;
determining, based on the second item quantity information, that a number of available vehicles at the first main center are insufficient to deliver a second item quantity of the ordered item;
transmitting instructions to a vehicle scheduled to return to the first main center to process the item related to a first category corresponding to the second item quantity information; and
transmitting instructions to a vehicle available in a second main center that received the order information to process the item related to a second category corresponding to the second item quantity information,
wherein the vehicles associated with the first item quantity information are allocated according to a priority among the vehicles available in consideration of stock information of the at least one sub-center
wherein a delivery based on the vehicle available in the second main center is processed within a shorter time than a delivery based on the vehicle scheduled to return to the first main center.

2. (canceled)

3. The information providing method of claim 1, wherein the checking of the information on the number of vehicles for each of the vehicle types comprises:
checking first information corresponding to a quantity of ordered items included in a specific category based on item category information corresponding to the ordered item information;
checking second information corresponding to a size of an ordered item included in the specific category; and
checking information on a number of vehicles for each of the vehicle types corresponding to the specific category based on the first information and the second information.

4. The information providing method of claim 3, wherein the information on the number of vehicles for each of the vehicle types is determined based on a comparison between the first information and the second information and a preset capacity out of a loading capacity of one of the vehicle types.

5. The information providing method of claim 1, wherein the order information is determined based on the stock information of the sub-center and stock information of the first main center.

6. The information providing method of claim 5, wherein the order information is determined based on history information of a delivery to a purchaser for a preset period in the sub-center.

7. The information providing method of claim 5, wherein:
the order information is updated every order date, and
a correspondence relationship between the sub-center and the first main center is updated every order date.

8. The information providing method of claim 7, wherein:
the sub-center corresponds to a center delivering an item ordered by a purchaser in a corresponding coverage range, and
the first main center corresponds to a center delivering an item to the at least one sub-center.

9. A non-transitory computer-readable recording medium on which a program allowing a computer to execute the method of claim 1 is recorded.

10. An electronic apparatus comprising:
a communication device;
a display; and
a controller configured to:
acquire order information for at least one sub-center from the at least one sub-center of a first main center via the communication device, the order information comprising ordered item information and item quantity information on an ordered item,
determine a number of vehicles for each of a plurality of vehicle types required for delivery of the ordered item to the at least one sub-center based on the ordered item information and the item quantity information, the plurality of vehicle types including freezer vehicles, refrigerator vehicles, and general vehicles,
provide the determined number of vehicles for each of the vehicle types required for delivery of the ordered item to the first main center via the communication device;
provide first item quantity information on an item quantity for which a vehicle is allocated and second item quantity information on an item quantity for which a vehicle is not allocated, among a quantity of items ordered for the at least one sub-center based on the item quantity information and the information on the number of vehicles for each of the vehicle types;
determine, based on the second item quantity information, that a number of available vehicles at the first main center are insufficient to deliver a second item quantity of the ordered item;
transmit instructions to a vehicle scheduled to return to the first main center to process the item related to a first category corresponding to the second item quantity information; and
transmit instructions to a vehicle available in a second main center that received the order information to process the item related to a second category corresponding to the second item quantity information,
wherein the vehicles associated with the first item quantity information are allocated according to a priority among the vehicles available in consideration of stock information of the at least one sub-center,
wherein a delivery based on the vehicle available in the second main center is processed within a shorter time than a delivery based on the vehicle scheduled to return to the first main center.

11. (canceled)

12. The electronic apparatus of claim 10, wherein the controller is configured to:
check first information corresponding to a quantity of ordered items included in a specific category based on item category information corresponding to the ordered item information,
check second information corresponding to a size of an ordered item included in the specific category, and
check information on a number of vehicles for each of the vehicle types corresponding to the specific category based on the first information and the second information.

13. The electronic apparatus of claim 12, wherein the information on the number of vehicles for each of the vehicle types is determined based on a comparison between the first information and the second information and a preset capacity out of a loading capacity of one of the vehicle types.

14. The electronic apparatus of claim 10, wherein the order information is determined based on history information of delivery to a purchaser for a preset period in the sub-center.
